(19) United States
(12) Patent Application Publication
(10) Pub. No.: US 2021/0308795 A1
(43) Pub. Date: Oct. 7, 2021

(54) Clamping Platen for Die Casting Machine and Manufacturing Method

(71) Applicant: Oskar Frech GmbH + Co. KG, Schorndorf (DE)

(72) Inventor: Alexander BAESGEN, Aalen (DE)

(21) Appl. No.: 17/218,437

(22) Filed: Mar. 31, 2021

(30) Foreign Application Priority Data
Apr. 1, 2020 (DE) 10 2020 204 269.1

(51) Int. Cl. B23K 26/342; B22D 17/22

(52) U.S. Cl. CPC B23K 26/342; B23K 2103/06; B22D 17/2209

(57) ABSTRACT

A clamping platen for a die casting machine has a base plate body of a cast iron material, a surface layer of a stainless steel material welded onto at least one plate side of the base plate body, and a transitional layer between the base plate body and the surface layer. The surface layer is applied as a laser weld application layer.

### CROSS REFERENCE TO RELATED APPLICATION

This application claims priority under 35 U.S.C. § 119 from German Patent Application No. 102020204269.1, filed Apr. 1, 2020, the entire disclosure of which is herein expressly incorporated by reference.

### BACKGROUND AND SUMMARY OF THE INVENTION

The invention is directed to a clamping platen for a die casting machine, wherein the clamping platen comprises a base plate body of a cast iron material, a surface layer of a stainless steel material welded onto at least one plate side of the base plate body, and a transitional layer between the base plate body and the surface layer; and a method for manufacturing such a clamping platen.

It is known, for fixed and movable clamping platens of die casting machines, to use a base plate body of a cast iron material and provide this, on at least one plate side which in particular may be the clamping side of the clamping platen facing a casting tool, with a surface layer as a protective layer of a stainless steel material or another surface protection material, in order to protect this plate side from corrosion e.g. from ambient humidity and/or from spray/separating agent, and/or from wear or the effects of mechanical impacts/shocks.

Patent publication EP 3 019 297 B1 discloses a clamping platen of the type cited initially in which the surface layer is a layer applied by pulse arc welding. To manufacture this clamping platen, a method is proposed in which the base plate body, on the plate side to be coated, is first subjected to a drying step in which it is heated to 150° C. to 180° C. This heating is sustained for a duration dependent on the predefined later application thickness of the surface layer, which duration is determined as one hour per 30 mm of planned application thickness. Then the surface layer is applied by direct pulse arc welding onto the surface to be coated using stainless steel as the filler material. The layer is applied by means of adjacent and overlapping weld beads, wherein the base plate body, on its plate side to be coated, is held at a temperature from 80° C. to 120° C. and the overlap of the weld beads is between 35% and 45%. The recommended stainless steel material in particular is a welding rod material designated as stainless steel 307 with 7% manganese. For the surface layer, a thickness of around 3 mm and in some cases slightly more is specified. The transitional layer, which is distinguished firstly by a greater hardness than the adjacent layers (i.e. the base plate body of cast iron material on one side and the surface layer of the stainless steel material on the other) and is present as a martensite layer, has a thickness of a few tenths of a millimetre.

The invention is based on the technical problem of providing a clamping platen of the type cited initially with an alternative surface coating, and an associated manufacturing method which allows the formation of the surface layer and the transitional layer with good coating properties and relatively low production complexity.

The invention solves this problem by providing a clamping platen which comprises a base plate body of a cast iron material, a surface layer of a stainless steel material welded onto at least one plate side of the base plate body, and a transitional layer between the base plate body and the surface layer. The surface layer is characteristically a laser weld application layer.

Surprisingly, it has been found that, with this formation of the surface layer as a laser weld application layer, the stainless steel material offers optimal protection against corrosion and mechanical impacts for the base plate body of cast iron material, and that favourable layer thicknesses can be achieved both for the surface layer and also for the transitional layer without a significant increase in production cost in comparison with conventional surface coatings of clamping platens. Thus for example usually there is no need for thermal pretreatment of the surface to be coated. The transitional layer forms a remelt layer or remelt zone as an interface layer between the base plate body of the cast iron material and the surface layer of the stainless steel material, wherein a comparatively hard remelt zone is formed by the surface liquefaction of the cast iron material of the base plate body under the effect of the laser beam used for the laser weld application process, and the addition and melting of the powdery stainless steel material.

Tests have shown that, by producing the surface layer as a laser weld application layer, a comparatively homogenous connection of the surface layer to the base plate body with good adhesion is achieved. It has been found in particular that the laser weld application layer has an optimal, homogenous material connection of the stainless steel material of the surface layer to the cast iron material of the base plate body with good substance bonding via the intermediate transitional layer.

The thermal load of the base plate body on its plate side to be coated may be kept relatively low for the formation of the surface layer by the laser weld application process, and the thickness of the transitional layer can accordingly be kept relatively low. The transitional layer formed by the laser weld application process has a comparatively high homogeneity and in general has a greater hardness than the adjacent layers, and in particular the outer surface layer, and thereby advantageously contributes to the overall hardness of the surface coating. This means inter alia that the surface of the clamping platen has a high resistance to scratching and impacts, which is advantageous for setting up a die casting machine.

The clamping platen according to the invention can advantageously be manufactured with the method according to the invention, and in particular provided with said surface coating. For this, the surface layer is applied to the plate side of the base plate body to be coated by means of the laser weld application process with formation of the transitional layer. In the laser weld application process, a laser beam spot is guided in rows over the plate side to be coated and a powdery stainless steel material is added, forming weld application beads of the stainless steel material which partially overlap transversely to the row direction. Residually, the process management for the laser weld application process may take place in a manner known to the person skilled in the art.

Because of the relatively low thermal load of the plate side to be coated, during the laser weld application process no significant or only very limited surface rippling occurs on the coating surface, which in turn allows a smaller layer thickness for the surface coating but nonetheless achieves a complete coverage of the base body surface on its respective coating side. To produce the surface coating with the necessary relatively small thickness, in most cases a single-row passage of the laser weld application process may suffice.

Advantageous embodiments of the invention are mentioned in the dependent claims, the wording of which is hereby made part of the description by reference. In particular this also includes all embodiments of the invention which arise from the feature combinations defined by the back references in the dependent claims.

In a refinement of the invention, the surface layer and the transitional layer together have an application thickness of maximum 2.5 mm. This constitutes an advantageously small layer thickness for the layer composition of the transitional layer and surface layer, wherein however optimal corrosion protection and mechanical protection may be provided by the surface layer. For this layer application, in general a single-row passage of the laser weld application process suffices, i.e. a single-layer arrangement of the weld beads. In alternative embodiments, a multi-row passage may be provided, i.e. the surface layer is then formed from several layers of weld beads lying one above the other.

In one embodiment, the surface layer and the transitional layer together have an application thickness of maximum 2.0 mm, which for corresponding applications has extensive advantages with respect to low production effort while still offering an adequate protective function of the surface coating.

In a refinement of the invention, the transitional layer has a layer thickness of maximum 0.5 mm. The low thickness of the transitional layer offers, inter alia, the advantage that despite its hardness, the transitional layer can be cut through relatively easily, e.g. for the purpose of introducing grooves or similar into the coated plate side of the clamping platen.

In an embodiment of the invention, the transitional layer has a layer thickness of maximum 0.3 mm. In yet a further embodiment, it has a layer thickness of maximum 0.15 mm. In yet a more particular embodiment, it has a layer thickness of maximum 0.1 mm. In stepped implementations, this constitutes furthermore a particularly thin transitional layer, wherein it has been found that a good material connection of the stainless steel material of the surface layer to the cast iron material of the base plate body is still retained.

In a refinement of the invention, the surface layer is face-machined. This is favourable in particular for applications in which a corresponding evenness or flatness of the clamping platen on its coated plate side is desirable in the final coated state.

In a refinement of the manufacturing method according to the invention, the layer is applied in the laser weld application process with an application thickness of maximum 2.5 mm, and after the laser weld application process, a facing process is performed which removes the surface layer down to a residual thickness of minimum 1 mm and maximum 2.2 mm. This allows provision of the clamping platen with a comparatively flat surface of its coated plate side, with simultaneously good protection against corrosion and mechanical impacts by the special laser weld application layer as the surface layer with relatively low layer thickness, with intermediation between the surface layer of the stainless steel material and the base plate body of the cast iron material by the also relatively thin transitional layer.

In corresponding embodiments, the layer is applied in the laser weld application process with a layer thickness of maximum 2.0 mm, and/or the surface layer is removed down to a residual thickness of minimum 1.4 mm and maximum 2.0 mm. This constitutes further measures in the production of the surface coating for the clamping platen which offer advantages for specific applications.

In a refinement of the invention, for the base plate body, a cast iron material with spheroidal graphite is used. This is a favourable and well-known material choice for a clamping platen.

In a refinement of the invention, as the powdery stainless steel material for forming the surface layer, a material is selected which contains between 16.0% and 22.0% chromium (Cr), 4.0% to 9.0% nickel (Ni), 0.4% to 6.0% manganese (Mn), 1.0% to 9.0% molybdenum (Mo), 0.03% to 0.4% carbon (C) and 0.1% to 0.8% silicon (Si). This results in a good applicability of the stainless steel material and a good substance-bonded material connection to the cast iron material of the base plate body.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic longitudinal section through a layer structure of a clamping platen of a die casting machine;

FIG. 2 shows a micrograph corresponding to FIG. 1 for a manufactured clamping platen;

FIG. 3 shows a schematic, perspective view to illustrate a laser weld application process which may be used for manufacturing the clamping platen; and

FIG. 4 shows a schematic, longitudinal sectional view to illustrate the laser weld application process.

### DETAILED DESCRIPTION OF THE DRAWINGS

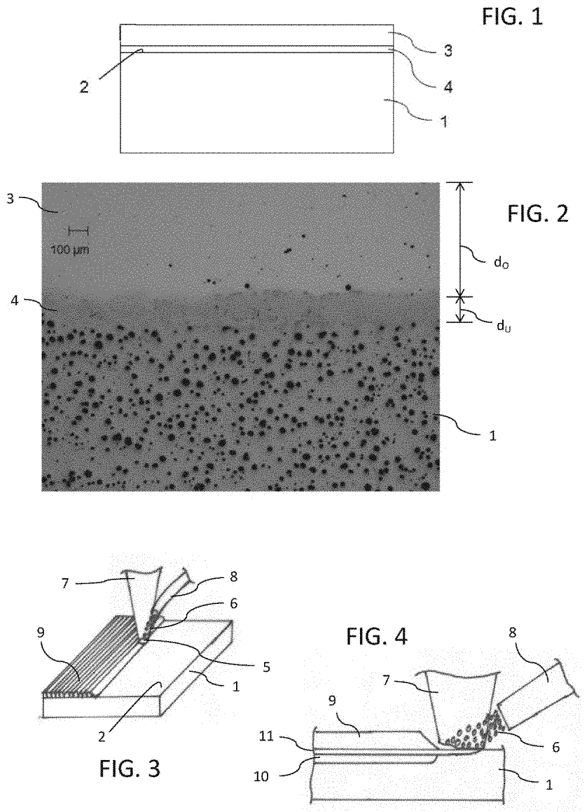

The clamping platen illustrated schematically in FIG. 1 and as a manufactured sample in FIG. 2, in a part area of interest here contains a base plate body 1 of a cast iron material, a surface layer 3 of a stainless steel material welded onto at least one plate side 2 of the base plate body 1, and a transitional layer 4 between the base plate body 1 and the surface layer 3. The surface layer 3 is in particular a laser weld application layer. The base plate body 1 may in particular consist of a cast iron material with spheroidal graphite.

To manufacture the clamping platen, firstly the base plate body 1 with the plate side 2 to be coated is provided. Optionally, the base plate body 1 is face-machined on its plate side 2 to be coated, i.e. its surface roughness is reduced by milling, grinding or other conventional facing processes. Then the surface layer 3 is applied to the plate side 2 to be coated by a laser weld application process, forming the intermediate transitional layer 4. During this laser weld application process, as illustrated schematically in FIGS. 3 and 4, a laser beam spot 5 is guided in rows over the plate side 2 to be coated and a powdery stainless steel material 6 is added. So a weld application bead 9 of the stainless steel material 6 is created along each row over which the laser beam spot 5 provided by the laser beam 7 moves, wherein the laser beam spot 5 is guided from one row to the next, from the left to the right in FIG. 3, such that respective adjacent weld application beads 9 partially overlap. As a powdery stainless steel material, in particular a commercial stainless steel welding material may be used which contains, in addition to the main constituent iron (Fe), between 16.0% and 22.0% Cr, 4.0% to 9.0% Ni, 0.4% to 6.0% Mn, 1.0% to 9.0% Mo, 0.03% to 0.4% C and 0.1% to 0.8% Si as minority constituents.

The process management for the laser weld application process may include for example the irradiation of the laser beam 7 with a power of 0.3 kW to 4.0 kW and an intensity between 10⁴ W/cm² and 10⁵ W/cm². Here, the cast iron material of the base plate body 1 liquefies superficially in the region of the laser beam spot 5, and a substance-bonded connection occurs with material bonding of the supplied powdery stainless steel material 6, which is melted in the region of the laser beam spot 5, with the superficially liquefied cast iron material. The powdery stainless steel material 6 is blown into the region of the laser beam spot 5, for example via a feed pipe 8 as shown, preferably under use of an inert gas such as argon or neon as a conveying gas. FIG. 4 illustrates schematically the formation of a heat influence zone 10 within which the cast iron material of the base plate body 1 liquefies superficially to the required extent, and a mixing zone 11 in which the material connection of the cast iron material and stainless steel material takes place, and on which then the primary stainless steel material is deposited in the form of the weld application bead 9 and hence the surface layer 3 is formed from the weld application beads 9.

In corresponding implementations, the surface layer 3 and the transitional layer 4 together have a layer thickness on the surface of the base plate body 1 of at most 2.5 mm and preferably at most 2.0 mm, e.g. approximately only 1.5 mm. Here, the transitional layer 4 in corresponding embodiments has a layer thickness du of at most 0.5 mm and preferably at most approximately 0.3 mm. In preferred embodiments, the layer thickness du of the transitional layer 4 is at most 0.15 mm, i.e. only around 0.15 mm or less, and in corresponding implementations only around 0.1 mm or less.

Optionally, after the end of the laser weld application process, the surface layer 3 formed from the individual weld application beads 9 is subjected to a facing process in which it is removed down to a residual thickness of at least 1 mm and maximum 2.2 mm, preferably to a residual thickness of at least 1.4 mm and maximum 2.0 mm. The surface layer 3 consequently has a final layer thickness do corresponding to this residual thickness, or in the case without facing, corresponding to the original application thickness of the surface layer 3 and transitional layer 4 less the layer thickness du of the transitional layer 4. Depending on the desired final flatness of the surface layer 3 and hence of the clamping platen on its coated plate side 2, for example between 0.4 mm and 0.6 mm of the original layer thickness of the surface layer 3 is removed in this facing process.

FIG. 2 illustrates in a micrograph an exemplary clamping platen manufactured in the manner explained above, in the surface region of interest here of its coated plate side 2. In this micrograph, the transitional layer 4 is clearly evident as a hard remelt zone with layer thickness du on the cast iron material of the base plate body 1, together with the surface layer 3 of stainless steel material with a layer thickness do rising from the transitional layer 4. This micrograph proves the formation of a substance-bonded, sufficiently homogenous connection of the corrosion-resistant surface layer 3 of the stainless steel material to the cast iron material of the base plate body 1 via the comparatively thin transitional layer 4.

If necessary, one or more further plate sides of the clamping platen may be provided with such a surface coating in the manner explained above with respect to plate side 2. As a whole therefore, according to the invention, a clamping platen is provided which has the specific laser weld application layer as a surface layer on only one or alternatively several plate sides, wherein the surface layer 3 can be formed with relatively little cost and if necessary relatively small layer thickness, with simultaneously good adhesion to the base plate body 1 and high resistance to corrosion and mechanical effects.

As the exemplary embodiments shown and those also explained above make clear, the invention provides a clamping platen with a highly advantageous surface layer of a stainless steel material which can be formed with relatively low production cost and offers high protection against corrosion effects and mechanical effects.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A clamping platen for a die casting machine, comprising:
a base plate body of a cast iron material;
a surface layer of a stainless steel material welded onto at least one plate side of the base plate body; and
a transitional layer between the base plate body and the surface layer,
wherein
the surface layer is a laser weld application layer.

2. The clamping platen according to claim 1, wherein
the surface layer and the transitional layer together have an application thickness of at most 2.5 mm.

3. The clamping platen according to claim 1, wherein
the surface layer and the transitional layer together have an application thickness of at most 2.0 mm.

4. The clamping platen according to claim 1, wherein
the transitional layer has a layer thickness of at most 0.5 mm.

5. The clamping platen according to claim 1, wherein
the transitional layer has a layer thickness of at most 0.3 mm.

6. The clamping platen according to claim 1, wherein
the transitional layer has a layer thickness of at most 0.15 mm.

7. The clamping platen according to claim 1, wherein
the transitional layer has a layer thickness of at most 0.1 mm.

8. The clamping platen according to claim 1, wherein
the surface layer is face-machined.

9. A method for manufacturing a clamping platen, the method comprising the steps of:
providing a base plate body of a cast iron material with a plate side to be coated; and
applying a surface layer of a stainless steel material onto the plate side to be coated by a laser weld application process, with formation of a transitional layer, wherein during the laser weld application process a laser beam spot is guided in rows over the plate side to be coated and a powdery stainless steel material is added, and weld application beads of the stainless steel material are formed which partially overlap transversely to the row direction.

10. The method according to claim 9, wherein
the layer is applied in the laser weld application process with an application thickness of at most 2.5 mm, and after the laser weld application process, a facing process is performed which removes the surface layer down to a residual thickness of at least 1 mm and at most 2.2 mm.

11. The method according to claim 10, wherein
the layer is applied in the laser weld application process with an application thickness of at most 2.0 mm.

12. The method according to claim 10, wherein
the surface layer is removed down to a residual thickness of at least 1.4 mm and at most 2.0 mm.

13. The method according to claim 9, wherein
for the base plate body, a cast iron material with spheroidal graphite is used.

14. The method according to claim 9, wherein
for the powdery stainless steel material, a material is selected which contains between 16.0% and 22.0% chromium (Cr), 4.0% to 9.0% nickel (Ni), 0.4% to 6.0% manganese (Mn), 1.0% to 9.0% molybdenum (Mo), 0.03% to 0.4% carbon (C), and 0.1% to 0.8% silicon (Si).
